(19) United States
(12) Patent Application Publication
(10) Pub. No.: US 2024/0292271 A1
(43) Pub. Date: Aug. 29, 2024

(54) SYSTEM AND METHOD FOR MANAGING NETWORK ELEMENTS OF OPEN RADIO ACCESS NETWORK (ORAN)

(71) Applicant: RAKUTEN MOBILE, INC., Tokyo (JP)

(72) Inventors: Sandeep Mani TRIPATHI, Tokyo (JP); Ramkumar MOORTHY, Tokyo (JP); Masahiko NANRI, Tokyo (JP)

(73) Assignee: RAKUTEN MOBILE, INC., Tokyo (JP)

(21) Appl. No.: 18/023,965

(22) PCT Filed: Jan. 31, 2023
(86) PCT No.: PCT/US2023/011924

§ 371 Date: Feb. 28, 2023

(51) Int. Cl. H04W 28/086; H04W 28/084; H04W 88/16

(52) U.S. Cl. CPC H04W 28/0864; H04W 28/084; H04W 88/16

(57) ABSTRACT

Provided are system, method, and device for managing one or more network elements of open radio access network (ORAN). According to embodiments, the system may include: a plurality of distributed units (DUs); a plurality of central units (CUs); a server comprising: a gateway, a memory storing instructions, and at least one processor configured to execute the instructions to configure the gateway to: establish a connection with one or more of: (a) at least one DU of the plurality of DUs, and (b) at least one CU of the plurality of CUs; and perform an action to the one or more of (a) the at least one DU, and (b) the at least one CU.

### TECHNICAL FIELD

Methods and systems consistent with example embodiments of the present disclosure relate to management of one or more network elements of an Open Radio Access Network (ORAN), and more specifically, relate to management of one or more distributed units (DUs) and one or more central units (CUs) in the ORAN.

### BACKGROUND

Related art radio access networks (RANs), such as Open RAN (ORAN) or any O-RAN compliant network architectures, disaggregate one network component into multiple functional or network elements. For instance, a baseband unit (BBU) or base station may be disaggregated into a number of network elements including at least one distributed unit (DU), and at least one central unit (CU).

The DU may receive radio signals from end users (via one or more user equipment (UE), etc.), and may provide operation or support for lower layers of protocol stacks (e.g., Radio Link Control (RLC) layer, Medium Access Control (MAC) layer, Physical Layer, etc.) accordingly. The CU may be communicatively coupled to the DU and a core network (e.g., 4G Evolved Packet Core (EPC) network, 5G Core network, etc.), and may receive the radio signals from the DU and then provide operation or support for higher layers of protocol stacks (e.g., Packet Data Convergence Protocol (PDCP) layer, Radio Resource Control (RRC) layer, etc.) accordingly.

Referring to FIG. 1, which illustrates a block diagram of an example system architecture 100 of an ORAN in the related art.

As illustrated in FIG. 1, the system 100 may include a plurality of UE (e.g., UE 110-1, UE 110-2, UE 110-3), a base station 120, a core network 140, and a management system 150. The base station 120 may include a single CU 130 and a plurality of DUs (e.g., DU 120-1, DU 120-2), the core network 140 (e.g., 4G EPC network, 5GC network, etc.) may include a Mobility Management Entity (MME) 140-1 and a Serving/Packet Gateway (SPGW) 140-2, and the management system 150 may include an Element Management System (EMS) 150-1 and an operational support system (OSS) 150-2.

The CU 130 may be communicatively coupled to the plurality of DUs (e.g., via F1 interface, etc.) and may provide control or serve the plurality of DUs. Further, the CU 130 may be communicatively coupled to the MME 140-1 and SPGW 140-2 of the core network 140 (e.g., via S1 interfaces, etc.), and may be communicatively coupled to the EMS 150-1 of the management system 150. Simply put, the CU 130 may act as an interface to the core network 140 (and the elements included therein) to provide one or more network communications or services (e.g., voice service, internet service, etc.), while the management system 150 may provide one or more management operations to one or more elements of the system 100.

It can be understood that, in practical, a single CU may support more than two DUs (e.g., hundreds of DU, thousands of DU, etc.), and each of the plurality of DUs may support more than two UE (e.g., tens of UE, hundreds of UE, etc.). Further, each of the plurality of DUs may support or serve a plurality of UE via one or more network cells, such as: one or more microcells, one or more Picocells, one or more Femtocells, or a combination thereof.

Each of the UE may transmit or receive (i.e., transceive) signals or data to-and-from a core network 140 via the base station 120. For instance, the UE 110-1 may transceive signals or data to-and-from the DU 120-1 (e.g., via air interface, via a radio unit (RU) communicatively coupled to the DU 120-1, etc.), the DU 120-1 may transceive said signals or data to-and-from the CU 130, and the CU 130 may transceive said signals or data to-and-from the core network 140.

To this end, each base station (e.g., 4G eNodeB, 5G gNodeB, etc.) may contain one CU, while said one CU may control or serve a plurality of DUs. In this regard, in the related art, a single CU may serve or support a significant number of DU, UE and network cells. Thus, whenever the number of DU, UE and/or network cells increases, the load which the single CU is handling may drastically increase.

In the related art, in response to the increasing amount of DU, UE, and/or network cells, the number of CU is increased in order to provide sufficient capacity to accommodate the increasing amount of DU, UE, and/or network cells. Nevertheless, such an approach may not be an optimal solution.

Specifically, the CU may be utilized to provide multiple functionalities, such as fault management and performance management, among others. In this regard, in order to add a new CU, resources (e.g., core powers, etc.) required for all CU functionalities would need to be reserved and be allocated to the new CU, regardless of whether or not the new CU will utilize all of the allocated resources. For instance, assuming that a first portion of DU, UE, and/or network cells may utilize CU for fault management, and a second portion of DU, UE, and/or network cells may utilize CU for performance management. In this regards, a first CU may be introduced or added to provide faulty management to the first portion of DU, UE, and/or network cells (i.e., the network resources reserved for operations other than fault management may not be utilized and may be wasted), and a second CU may be introduced or added to provide performance management to the second portion of DU, UE, and/or network cells (i.e., the network resources reserved for operations other than performance management may not be utilized and may be wasted). In view of the above, increasing the number of CU will increase the network resource consumption/reservation, as well as will increase the resources (e.g., EMS, etc.) required for managing the increasing number of CU.

Further, in the related art, since the CU is responsible for performing a significant amount of operations, the CU may not have sufficient resources (e.g., core power, bandwidth, etc.) to efficiently and effectively perform all operations. For instance, assuming that a CU has been allocated 10 processing cores, and the CU is required to perform operations for fault management which require a processing power of 7 cores and is required to perform operations for performance management which require a processing power of 6 cores. In this regards, the CU may not able to simultaneously perform the operations for both fault management and performance management, or may require to perform said operations under sub-optimal condition (e.g., perform with lower processing power which in turns result in lower efficiency, perform the operations in sequential manner, etc.).

Furthermore, the deployment of the CU in the related art may also limit the optimization of resources. Specifically, the disaggregation of network elements enables the network elements (e.g., CU) and the associated functions to be defined and provided in software-based form or virtual network services, such as Virtualized Network Functions (VNFs), Cloud-native Network Functions (CNFs) or Software Defined Networking (SDN), among others. Accordingly, the software-based network elements may be deployed or hosted in, for example, a server cluster such as a hybrid cloud server, data center servers, and the like. The software-based network elements may be containerized and may be deployed and controlled by one or more machines, called as “nodes”, that run or execute the containerized network elements. In this regards, a server cluster may contains at least one master node and a plurality of worker nodes, wherein the master node(s) controls and manages a set of associated worker nodes.

In this regard, a CU may be virtualized and may be deployed in software form, and the virtualized CU (vCU) may be hosted or be stored in a location different from the associated DUs. By way of an example, in the related art, the vCU is usually being hosted or be deployed in a server cluster of a regional data center (RDC), which may be separated from the location at which the DUs were installed or deployed. By hosting or deploying the CU at the RDC, the size of the site (e.g., radio tower, etc.) may be reduced and the choices for installing/deploying the network elements may increase.

Nevertheless, the server cluster of the RDC usually contains a significant amount of worker nodes, which in turns increasing the criticality and essentiality of the master node of the server cluster, since an error or a failure in the master node may directly impact the significant amount of worker nodes. Thus, in the related art, the CU is typically deployed in the worker nodes of the server cluster. In this regards, whenever a scaling-up of CU (e.g., addition of new CU, etc.) is required, the CU will be hosted or deployed in an existing worker nodes, or new worker node(s) may need to be added or introduced to host the CU. Thus, the scaling-up of CU may be less flexible and may increase the load of the master node.

Furthermore, since the CU in the related art is usually hosted or deployed in a server of RDC (which may not be located nearby the end user), network operations (e.g., handover operation, restarting operation, etc.) performed by the CU may be less efficient, particularly when the operations require low latency or fast response.

### SUMMARY

Example embodiments of the present disclosure provides a system, a method, and a device to efficiently and effectively manage one or more network elements of Open Radio Access Network (ORAN). Specifically, at least one gateway is utilized in the example embodiments, so as to provide an optimal solution for accommodating the increasing number of network elements in ORAN, as well as optimizing the utilization of resources and improve the efficiency and effectiveness of network operations.

According to embodiments, a system is provided. The system may include: a plurality of distributed units (DUs); a plurality of central units (CUs); and a server including: a gateway, a memory storing instructions, and at least one processor configured to execute the instructions to configure the gateway to: establish a connection with one or more of: (a) at least one DU of the plurality of DUs, and (b) at least one CU of the plurality of CUS; and perform an action to the one or more of (a) the at least one DU, and (b) the at least one CU.

According to embodiments, the at least one processor may be configured to execute the instructions to configure the gateway to establish the connection with the at least one DU; and the at least one processor may be configured to execute the instructions to configure the gateway to perform the action by: receiving at least one protocol data unit (PDU) from the at least one DU; determining, from the plurality of CUs, at least one target CU to which the at least one PDU should be transmitted; and transmitting the at least one PDU to the at least one target CU.

According to embodiments, the at least one processor may be configured to execute the instructions to configure the gateway to establish the connection with the at least one CU; and the at least one processor may be configured to execute the instructions to configure the gateway to perform the action by: receiving at least one protocol data unit (PDU) from the at least one CU; determining, from the plurality of DUs, at least one target DU to which the at least one PDU should be transmitted; and transmitting the at least one PDU to the at least one target DU.

According to embodiments, the receiving the at least one PDU may include receiving the at least one PDU from the at least one DU via a Radio Link Control (RLC) layer; and the at least one PDU may include at least one PDU for a signaling radio bearer (SRB), at least one PDU for a data radio bearer (DRB), or a combination thereof.

According to embodiments, the receiving the at least one PDU may include receiving the at least one PDU from the at least one CU via a Packet Data Convergence Protocol (PDCP) layer; and the at least one PDU may include at least one PDU for a SRB, at least one PDU for a DRB, or a combination thereof.

According to embodiments, the server may be a server of an edge data center.

According to embodiments, the server may be a server cluster, the server cluster may include at least one master node and a plurality of worker nodes associated with the at least one master node, and the gateway may be hosted in the at least one master node, the plurality of worker nodes, or a combination thereof.

According to embodiments, a method is provided. The method may be performed by a gateway of a server, and may include: establishing, by the gateway, a connection with one or more of: (a) at least one distributed unit (DU) of a plurality of DUs, and (b) at least one central unit (CU) of a plurality of CUs; and performing, by the gateway, an action to the one or more of (a) the at least one DU, and (b) the at least one CU.

According to embodiments, the establishing the connection may include establishing the connection with the at least one DU; and the performing the action may include: receiving at least one protocol data unit (PDU) from the at least one DU; determining, from the plurality of CUs, at least one target CU to which the at least one PDU should be transmitted; and transmitting the at least one PDU to the at least one target CU.

According to embodiments, the establishing the connection may include establishing the connection with the at least one CU; and the performing the action may include: receiving at least one protocol data unit (PDU) from the at least one CU; determining, from the plurality of DUs, at least one target DU to which the at least one PDU should be transmitted; and transmitting the at least one PDU to the at least one target DU.

According to embodiments, the receiving the at least one PDU may include receiving the at least one PDU from the at least one DU via a Radio Link Control (RLC) layer; and the at least one PDU may include at least one PDU for a signaling radio bearer (SRB), at least one PDU for a data radio bearer (DRB), or a combination thereof.

According to embodiments, the receiving the at least one PDU may include receiving the at least one PDU from the at least one CU via a Packet Data Convergence Protocol (PDCP) layer; and the at least one PDU may include at least one PDU for a SRB, at least one PDU for a DRB, or a combination thereof.

According to embodiments, the server may be a server of an edge data center.

According to embodiments, the server may be a server cluster, the server cluster may include at least one master node and a plurality of worker nodes associated with the at least one master node, and the gateway may be hosted in the at least one master node, the plurality of worker nodes, or a combination thereof.

According to embodiments, a non-transitory computer-readable recording medium is provided. The non-transitory computer-readable recording medium may have recorded thereon instructions executable by at least one processor to cause the at least one processor to configure a gateway of a server to perform a method including: establishing, by the gateway, a connection with one or more of: (a) at least one distributed unit (DU) of a plurality of DUs, and (b) at least one central unit (CU) of a plurality of CUs; and performing, by the gateway, an action to the one or more of (a) the at least one DU, and (b) the at least one CU.

According to embodiments, the establishing the connection may include establishing the connection with the at least one DU; and the performing the action may include: receiving at least one protocol data unit (PDU) from the at least one DU; determining, from the plurality of CUs, at least one target CU to which the at least one PDU should be transmitted; and transmitting the at least one PDU to the at least one target CU.

According to embodiments, the establishing the connection may include establishing the connection with the at least one CU; and the performing the action may include: receiving at least one protocol data unit (PDU) from the at least one CU; determining, from the plurality of DUs, at least one target DU to which the at least one PDU should be transmitted; and transmitting the at least one PDU to the at least one target DU.

According to embodiments, the receiving the at least one PDU may include receiving the at least one PDU from the at least one DU via a Radio Link Control (RLC) layer; and the at least one PDU may include at least one PDU for a signaling radio bearer (SRB), at least one PDU for a data radio bearer (DRB), or a combination thereof.

According to embodiments, the receiving the at least one PDU may include receiving the at least one PDU from the at least one CU via a Packet Data Convergence Protocol (PDCP) layer; and the at least one PDU may include at least one PDU for a SRB, at least one PDU for a DRB, or a combination thereof.

According to embodiments, the server may be a server of an edge data center.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates block diagrams of an example system architecture of ORAN in the related art;

FIG. 2A illustrates block diagrams of a first configuration of an example system architecture for managing network elements of ORAN, according to one or more embodiments;

FIG. 2B illustrates block diagrams of a second configuration of the example system architecture for managing network elements of ORAN, according to one or more embodiments;

FIG. 3 illustrates a diagram of an example environment in which systems and/or methods, described herein, may be implemented, according to one or more embodiments;

FIG. 4 illustrates a diagram of example components of a device, according to one or more embodiments;

FIG. 5 illustrates a flow diagram of a general method for managing one or more network elements of ORAN, according to one or more embodiments;

FIG. 6 illustrates a flow diagram of a method for managing data packets transmission among network elements of ORAN, according to one or more embodiments;

FIG. 7 illustrates a flow diagram of a method for performing a handover operation among network elements of ORAN, according to one or more embodiments; and

FIG. 8 illustrates a flow diagram of a method for performing a restart operation on a network element of ORAN, according to one or more embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provides a system, a method, and a device to efficiently and effectively manage one or more network elements of Open Radio Access Network (ORAN), such as one or more network elements in any O-RAN compliant system. Specifically, at least one gateway is utilized in the example embodiments, wherein the at least one gateway may reduce the load of the CU by performing one or more operations on-behalf of the CU. Further, the at least one gateway may be hosted or deployed in a server of an edge data center (EDC), and may be easily deployed/redeployed among servers and nodes according to the requirement or the status of resources.

Ultimately, example embodiments of the present disclosure provide an optimal solution for accommodating the increasing number of network elements (e.g., DU, UE, network cells, etc.) in ORAN, as well as optimizing the utilization of resources and improve the efficiency and effectiveness of network operations.

### General System Architecture

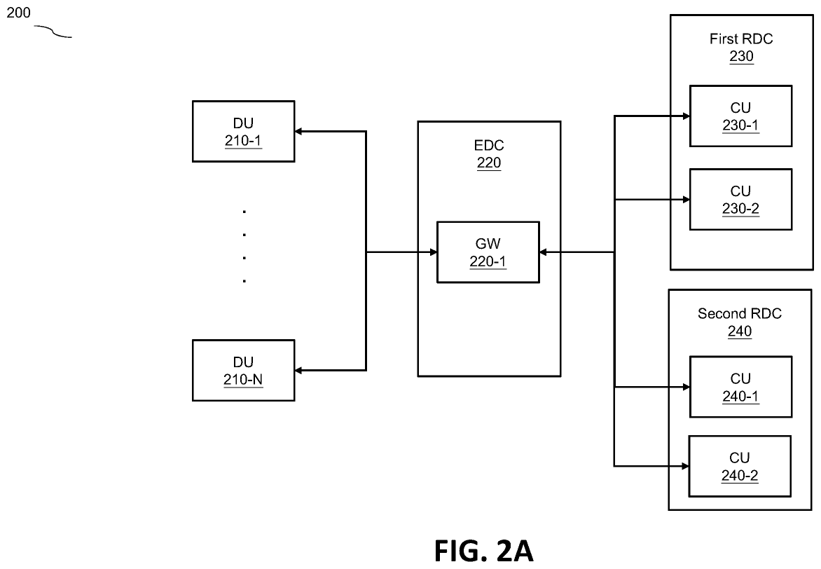

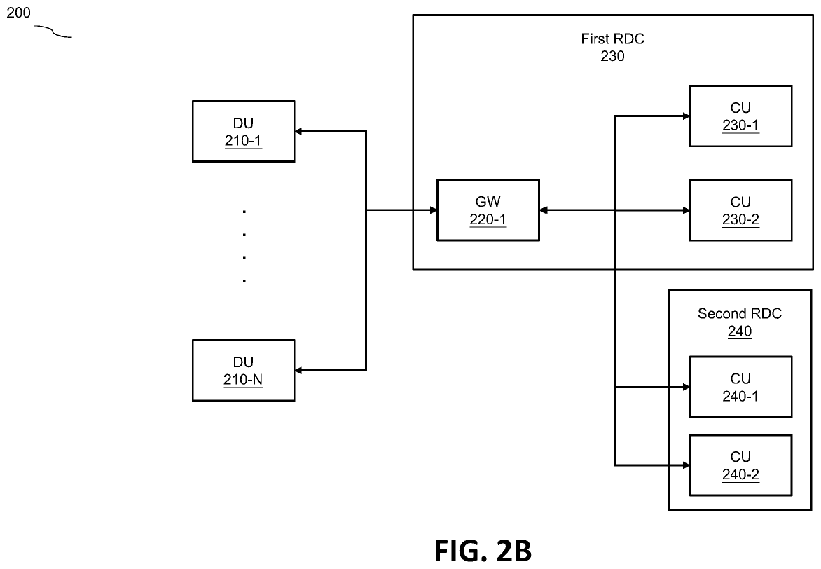

FIG. 2A illustrates block diagrams of a first configuration of an example system architecture for managing network elements of ORAN, according to one or more embodiments.

Referring FIG. 2A, a system 200 may include a plurality of distributed units (DUs) (i.e., DU 210-1 to DU 210-N), at least one gateway (GW) 220-1 hosted or deployed in an edge data center (EDC) 220, and a plurality of central units (i.e., CU 230-1 and CU 230-2 hosted or deployed in a first regional data center (RDC) 230, and CU 240-1 and CU 240-2 hosted or deployed in a second RDC 240).

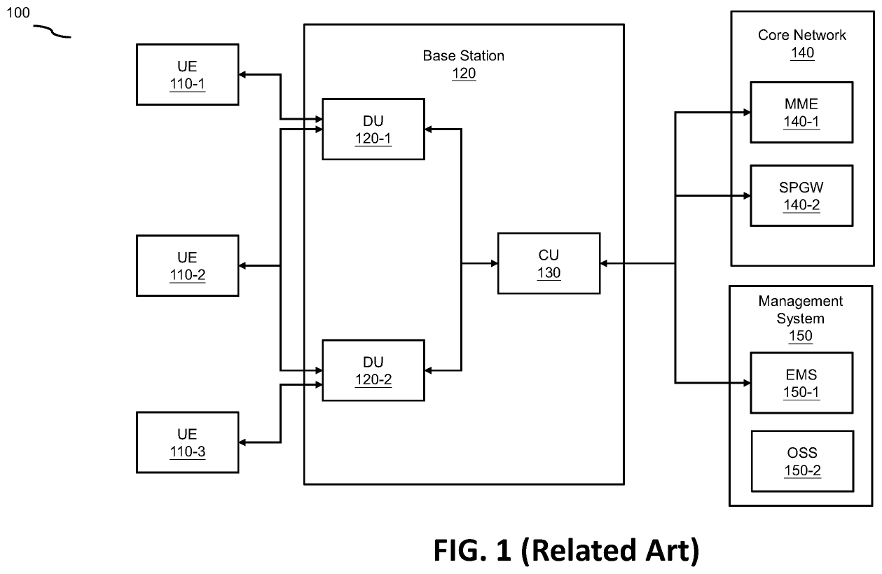

As described hereinabove with reference to FIG. 1, the plurality of DUs may be communicatively coupled to a plurality of end users via a respective user equipment (UE) or user device. Further, each of the plurality of CUs may constitute a base station (e.g., 4G eNodeB, 5G gNodeB, etc.), and may have a base station ID associated therewith. Further, the plurality of CUs may be deployed in software-form (e.g., virtualized and/or containerized), and may be hosted or stored in a server or a server cluster of the respective RDC. Furthermore, it can be understood that each of the plurality of CUs may be communicatively coupled to a core network (or one or more elements included therein) and/or may be communicatively coupled to a management system (or one or more elements included therein), in a similar manner as described hereinabove with reference to FIG. 1.

As illustrated in FIG. 2A, the GW 220-1 may be communicatively coupled to the plurality of DUs and the plurality of CUs, and may be configured to receive signals or data therefrom and/or to transmits signals or data thereto.

According to embodiments, the GW 220-1 may be configured to manage data packets transmission among the plurality of DUs and the plurality of CUs. For instance, the DU GW 220-1 may aggregate/collect and may distribute/transmit Protocol Data Unit (PDU) as per bearer (e.g., signaling radio bearer (SRB), data radio bearer (DRB), etc.) and/or as per protocol layer. For instance, the GW 220-1 may aggregate/collect PDU for SRB and/or DRB from one or more of the DUs via Radio Link Control (RLC) layer and may distribute/transmit the aggregated PDU to an associated CU(s) (e.g., transmit to a Service Access Point (SAP) of the associated CU(s), etc.). As another example, the GW 220-1 may aggregate/collect PDU for SRB and/or DRB from one or more of the CUs via Packet Data Convergence Protocol (PDCP) layer and may distribute/transmit the aggregated PDU to the associated DU(s) via the associated RLC layer.

Further, the GW 220-1 may obtain or share information which utilized by the plurality of CUs and/or the plurality of DUs. For instance, the GW 220-1 may obtain or share information, such as application layer information, control information, base station information (e.g., base station ID, load information of CU, etc.), fault/error information, and resource information (e.g., utilized resources, available resources, etc.), among others.

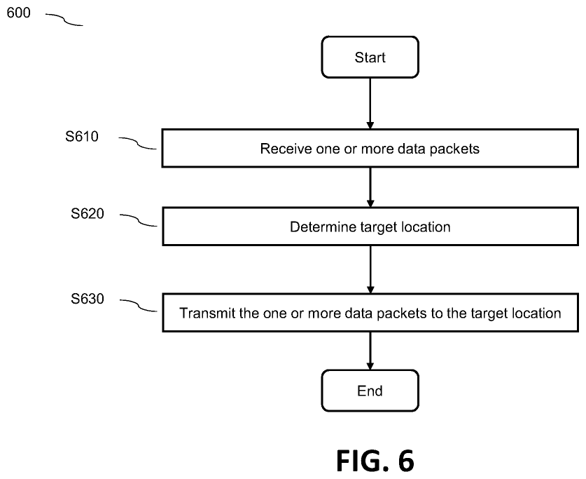

In view of the above, the GW 220-1 may perform one or more operations or functionalities a CU(s), as well as may automatically manage the communication between the plurality of CUs and the plurality of DUs, on-behalf of the CU(s). For instance, the GW 220-1 may manage the data packet transmission (e.g., may determine a target location of a received data packet(s), may process the received data packet(s), etc.), may perform one or more fault management operations (e.g., generate error message, etc.), may initiate and manage the handover operations on-behalf of the CU(s), may restart a network element, and the like, on-behalf of the CU(s). Descriptions of several example use cases are provided below with reference to FIG. 6 to FIG. 8.

Further, the GW 220-1 may be virtualized/containerized and may be deployed in software form. According to embodiments, the GW 220-1 may be hosted or deployed in an data center separated from the data center hosting/deploying the CUs. For instance, as illustrated in FIG. 2A, the GW 220-1 may be hosted in a server or a server cluster of an edge data center (e.g., EDC 220), while the CUS may be hosted in one or more regional data centers (e.g., first RDC 230, second RDC 240, etc.). To this end, since the number of worker nodes supported/served by the master node(s) in the EDC is significantly lower than the number of worker nodes supported/served by the master node(s) in the RDC (i.e., the criticality of the master node(s) is significantly lesser in EDC as compared to RDC), the GW 220-1 may be hosted or deployed in one or more of the master node(s), the worker node(s), or a combination thereof, according to the performance requirement and/or availability of resources.

Furthermore, since the functionalities of GW 220-1 are less complicated than a CU (i.e., the size of the GW 220-1 may be smaller than the CU), the GW 220-1 may be easily hosted/deployed or re-hosted/re-deployed among the worker nodes and master node(s) and/or among the servers of multiple datacenters. Accordingly, the utilization of resources may be easily configured/reconfigured to achieve an optimal configuration, and the requirement for scaling-up the CU for accommodating the increasing number of network elements (e.g., UE, DU, and/or network cells) may be reduced or eliminated.

In addition, since the GW 220-1 may be hosted or deployed in the EDC (which is nearer to the end users) and may perform one or more actions or operations on behalf of the CU(s), the efficiency and effectiveness for providing or performing the one or more actions or operations (particularly for action(s) or operation(s) which require low latency) may be improved.

It is contemplated that the example embodiments described above are merely possible embodiments, and the scope of the present disclosure should not be limited thereto. For instance, the GW 220-1 may perform any other suitable actions or functionalities of CU, without departing from the scope of the present disclosure.

Further, the GW 220-1 may also be hosted or deployed in any suitable datacenter. For instance, referring to FIG. 2B, which illustrates block diagrams of a second configuration of the example system architecture for managing network elements of ORAN, according to one or more embodiments. The role, functionality, and operations of the elements in system 200 may be similar to those described hereinabove with reference to FIG. 2A. Thus, redundant descriptions may be omitted below for conciseness.

As illustrated in FIG. 2B, the GW 220-1 may be hosted or deployed in a regional datacenter (e.g., RDC 230) in which the CUS (e.g., CU 230-1, CU 230-2) are hosted or deployed. On the other hand, the GW 220-1 may be hosted or deployed in a regional datacenter different from the regional datacenter in which the CUs (e.g., CU 240-1, CU 240-2) are hosted or deployed. It can be understood that the GW 220-1 may also be hosted or deployed in any other suitable location, without departing from the scope of the present disclosure.

### General Implementation Environment & Components of Devices

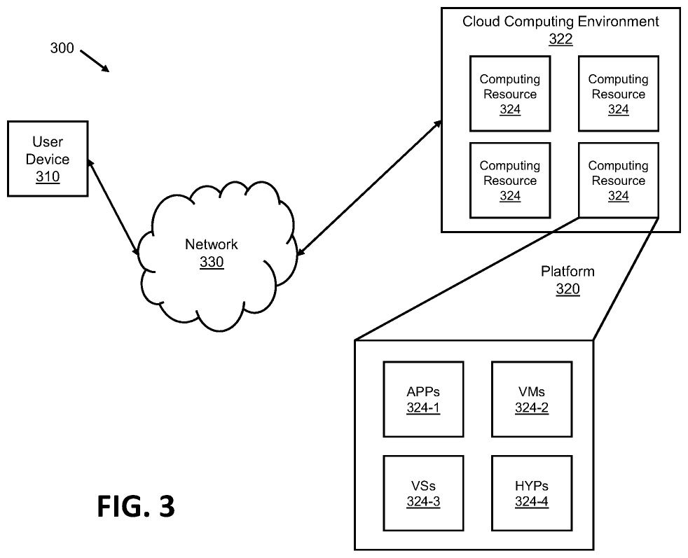

FIG. 3 illustrates a diagram of an example environment 300 in which systems and/or methods, described herein, may be implemented, according to one or more embodiments.

As shown in FIG. 3, environment 300 may include a user device 310, a platform 320, and a network 330. Devices of environment 300 may interconnect via wired connections, wireless connections, or a combination of wired and wireless connections. In embodiments, any of the functions and operations described above with reference to FIG. 2A and FIG. 2B may be performed by any combination of elements illustrated in FIG. 3.

User device 310 may include one or more devices communicatively coupled to platform 320 via the network 330. For instance, user device 310 may include one or more user equipment (UE) communicatively coupled to platform 320 in which one or more software-based network elements (e.g., virtualized CU, etc.) are hosted or deployed. According to embodiments, user device 310 may include one or more devices capable of receiving, generating, storing, processing, and/or providing information associated with platform 320. For example, user device 310 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), a SIM-based device, or any other suitable device. In some implementations, user device 310 may receive information or data from and/or transmit information or data to platform 320.

Network 330 may include one or more wired and/or wireless networks or may include one or more elements constituting the one or more wired and/or wireless network. For example, network 330 may include a cellular network (e.g., a fifth generation (5G) network, a fourth generation (4G)/long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

According to embodiments, network 330 may include a first portion of network elements such as one or more radio units (RUs), one or more distributed units (DUs), and the like, and may be configured to communicatively couple the user device 310 to platform 320 and enable the user device 310 to communicate with or utilize a second portion of network elements (e.g., virtualized CUs, etc.) hosted or deployed in the platform 320.

Platform 320 may include one or more devices capable of receiving, generating, storing, processing, and/or providing information or data. In some implementations, platform 320 may include a cloud server or a group of cloud servers. In some implementations, platform 320 may be designed to be modular such that certain software components may be swapped in or out depending on a particular need. As such, platform 320 may be easily and/or quickly reconfigured for different uses.

In some implementations, platform 320 may be hosted or deployed in one or more data centers (e.g., regional data center (RDC), edge data center (EDC), etc.). For instance, platform 320 may be hosted or deployed in a server or a server cluster of a data center. Alternatively, platform 320 may be hosted or deployed in a plurality of servers or a plurality of server clusters in a plurality of data centers (e.g., a plurality of RDCs, a plurality of EDCs, etc.). Further, a first portion of platform 320 may be hosted or deployed in a server or a server cluster in a first data center (e.g., a first RDC, a first EDC, etc.), and a second portion of platform 320 may be hosted or deployed in a server or a server cluster in a second data center (e.g., a second RDC, a second EDC, etc.).

In some implementations, platform 320 may be hosted in a cloud computing environment 322. Notably, while implementations described herein describe platform 320 as being hosted in cloud computing environment 322, in some implementations, platform 320 may not be cloud-based (i.e., may be implemented outside of a cloud computing environment) or may be partially cloud-based.

Cloud computing environment 322 may include an environment that hosts platform 320. Cloud computing environment 322 may provide computation, software, data access, storage, etc. services that do not require end-user (e.g., user device 310) knowledge of a physical location and configuration of system(s) and/or device(s) that hosts platform 320. As shown, cloud computing environment 322 may include a group of computing resources 324 (referred to collectively as “computing resources 324” and individually as “computing resource 324”).

Computing resource 324 may include one or more personal computers, a cluster of computing devices, workstation computers, server devices, or other types of computation and/or communication devices. In some implementations, computing resource 324 may host platform 320. The cloud resources may include compute instances executing in computing resource 324, storage devices provided in computing resource 324, data transfer devices provided by computing resource 324, or the like. In some implementations, computing resource 324 may communicate with other computing resources 324 via wired connections, wireless connections, or a combination of wired and wireless connections.

As further shown in FIG. 3, computing resource 324 may include a group of resources, such as one or more applications (“APPs”) 324-1, one or more virtual machines (“VMs”) 324-2, one or more virtualized storage (“VSs”) 324-3, one or more hypervisors (“HYPs”) 324-4, or the like.

Application 324-1 may include one or more software applications that may be provided to or accessed by user device 310. Application 324-1 may eliminate a need to install and execute the software applications on user device 310. For example, application 324-1 may include software associated with platform 320 and/or any other software capable of being provided via cloud computing environment 322. In some implementations, one application 324-1 may send/receive information to/from one or more other applications 324-1, via virtual machine 324-2. In some embodiments, application 324-1 may include one or more software-based network elements (e.g., virtualized CUs, virtualized gateway, etc.).

Virtual machine 324-2 may include a software implementation of a machine (e.g., a computer) that executes programs like a physical machine. Virtual machine 324-2 may be either a system virtual machine or a process virtual machine, depending upon use and degree of correspondence to any real machine by virtual machine 324-2. A system virtual machine may provide a complete system platform that supports execution of a complete operating system (“OS”). A process virtual machine may execute a single program, and may support a single process. In some implementations, virtual machine 324-2 may execute on behalf of a user (e.g., user device 310), and may manage infrastructure of cloud computing environment 322, such as data management, synchronization, or long-duration data transfers.

Virtualized storage 324-3 may include one or more storage systems and/or one or more devices that use virtualization techniques within the storage systems or devices of computing resource 324. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 324-4 may provide hardware virtualization techniques that allow multiple operating systems (e.g., “guest operating systems”) to execute concurrently on a host computer, such as computing resource 824. Hypervisor 324-4 may present a virtual operating platform to the guest operating systems, and may manage the execution of the guest operating systems. Multiple instances of a variety of operating systems may share virtualized hardware resources.

It is contemplated that the terms “virtual”, “virtualized”, or the like, described above are merely intended to specify the nature of the machine (and the elements and resources associated therewith) being provided in virtual or software form. In this regard, the “virtual machine”, “virtualized storage”, and the like, described above should not be limited to any specific type of virtual machine or virtual element. Specifically, in some embodiments, application 324-1 may include one or more containerized elements or services (e.g., a network function (function of CU, function of DU gateway, etc.) may be provided in a form of a container, and a plurality of containerized network functions may be hosted or deployed in a pod to thereby form a microservice, etc.), and virtual machine 324-2 may include one or more containers configured to manage and/or utilize the one or more containerized elements or services.

To this end, the number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

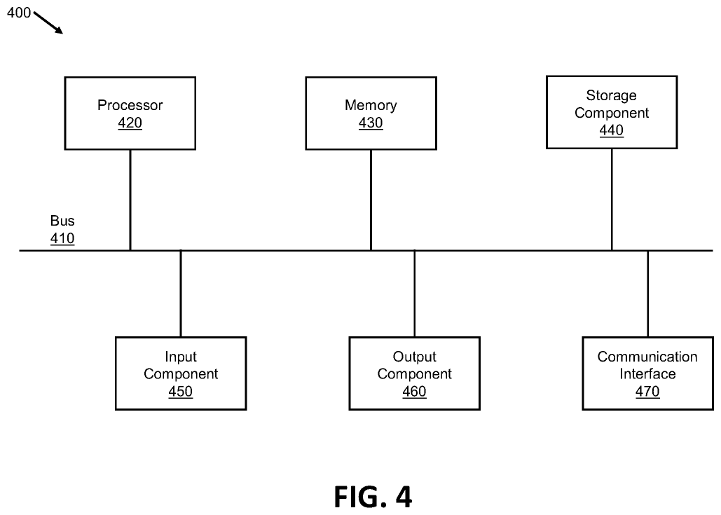

FIG. 4 illustrates a diagram of example components of a device 400, according to one or more embodiments. Device 400 may correspond to user device 310 and/or platform 320 in FIG. 3. According to embodiments, device 400 may correspond to a server or a server cluster hosting or deploying at least one gateway (e.g., GW 220-1 in FIG. 2A and FIG. 2B).

As shown in FIG. 4, device 400 may include at least one bus 410, at least one processor 420, at least one memory 430, at least one storage component 440, at least one input component 450, at least one output component 460, and at least one communication interface 470.

Bus 410 may include one or more components that permits communication among the components of device 400. Processor 420 may be implemented in hardware, firmware, or a combination of hardware and software. Processor 420 may include at least one central processing unit (CPU), at least one graphics processing unit (GPU), at least one accelerated processing unit (APU), at least one microprocessor, at least one microcontroller, at least one digital signal processor (DSP), at least one field-programmable gate array (FPGA), at least one application-specific integrated circuit (ASIC), or another type of processing component. In some implementations, processor 420 may include one or more processors capable of being programmed to perform a function or an operation.

Memory 430 may include a random access memory (RAM), a read only memory (ROM), and/or another type of dynamic or static storage device (e.g., a flash memory, a magnetic memory, and/or an optical memory) that stores information and/or instructions for use by processor 420.

Storage component 440 may store information and/or software related to the operation and use of device 400. For example, storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 450 may include a component that permits device 400 to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 may include a component that provides output information from device 400 (e.g., a display, a speaker, and/or one or more light-emitting diodes (LEDs)).

Communication interface 470 may include a transceiver-like component (e.g., a transceiver and/or a separate receiver and transmitter) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, or the like.

Device 400 may perform one or more processes described herein. Device 400 may perform these processes in response to processor 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices. In some implementations, the processor 420 may execute the software instructions to configure a component of the device 400 to perform one or more processes or operations.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein. For instance, at least one gateway may be hosted or stored in the memory 430, the storage component 440, and/or any other storage medium(s) communicatively coupled to the processor 420, and the processor 420 may, when executing the instructions stored in memory 430 and/or storage component 440, configure the at least one gateway to perform one or more operations or processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

### General Operations of Gateway

As described above, example embodiments of the present disclosure provide systems and methods which utilize at least one gateway (e.g., GW 220-1 in FIG. 2A and FIG. 2B) to manage one or more network elements of ORAN. The at least one gateway may be virtualized or deployed in software-form, may be hosted or deployed in a server or a computer platform (e.g., platform 320 in FIG. 3), and may be utilized or configured by one or more elements of the server or the computer platform (e.g., processor 420 in FIG. 4, etc.) to perform one or more operations or actions for managing the network elements.

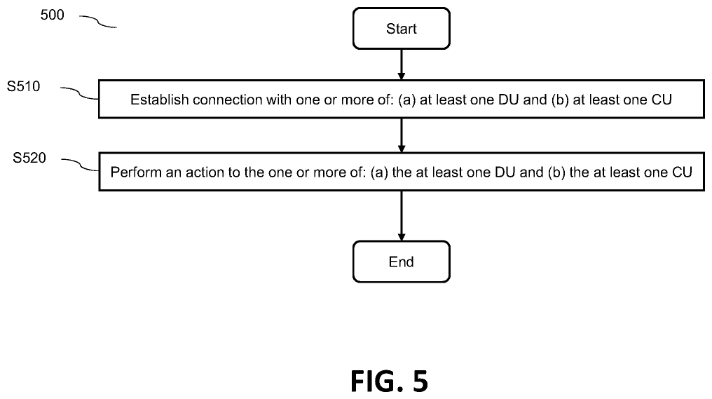

FIG. 5 illustrates a flow diagram of a general method 500 for managing at least one network element of ORAN, according to one or more embodiments.

Method 500 may be performed by at least one gateway hosted or deployed in a server (e.g., a server in an edge data center (EDC), a server in a regional data center (RDC), etc.). Specifically, at least one processor of the server may, when executing one or more computer readable or executable instructions stored in a memory of the server, configure or utilize the at least one gateway to perform one or more operations of method 500. Further, as explained above with reference to FIG. 2A, the at least one gateway may be hosted or deployed in a server or a server cluster of the EDC, wherein the server cluster may include at least one master node and a plurality of worker nodes, and the at least one gateway may be hosted or deployed in the at least one master node, the plurality of worker nodes, or a combination thereof.

Furthermore, as explained above with reference to FIG. 2A and FIG. 2B, the at least one gateway may be communicatively coupled to a plurality of DUs and a plurality of CUs (e.g., a plurality of CUs hosted or deployed in a server of a regional data center (RDC), etc.). In this regards, it may be understood that the at least one gateway may perform one or more operations of method 500 to manage one or more of: (a) at least one DU of a plurality of DUs, and (b) at least one CU of a plurality of CUs.

Referring to FIG. 5, at operation S510, the at least one gateway may be configured to establish a connection with one or more of (a) at least one DU and (b) at least one CU.

Specifically, the at least one gateway may retrieve from and/or share with one or more storage mediums (e.g., virtualized storages 324-3 in FIG. 3, memory 430 and/or storage component 440 in FIG. 4, etc.) information of a plurality DUs and/or information of a plurality of CUs. The information may be provided or updated continuously (or periodically) by the plurality of DUs, the plurality of CUs, and/or any suitable element (e.g., database authorized by an operator of the network, etc.) to the one or more storage mediums. The information may include ID associated each DU/each CU, service access point (SAP) information associated with each CU, server/datacenter information in which each DU/each CU is stored, resource status, health status, and any other suitable information. Accordingly, based on the information, the at least one gateway may determine which of the plurality of DUs and the plurality of CUs is required to be managed, and may thereby establish a connection therewith.

For instance, the at least one gateway may determine that a DU and/or a CU would like to has an action or an operation performed thereto (e.g., a newly added DU would like to transmit a data packet to a CU, a CU would like to initiate a handover operation to handover a DU to another CU, a DU would like be restarted, etc.). Accordingly, the at least one gateway may establish a connection with the associated DU(s) and/or CU(s). It is contemplated that the at least one gateway may establish the connection with the associated DU(s) and/or CU(s) via any suitable operation or process under any suitable condition, without departing from the scope of the present disclosure.

Additionally or alternatively, the at least one gateway may receive a request for connection from the at least one DU and/or the at least one CU, and may thereby establish a connection to the at least one DU and/or the at least one CU accordingly.

According to embodiments in which the at least one gateway establishes connection with the at least one DU and the at least one CU, the at least one gateway may establish the connection in any suitable order. For instance, the at least one gateway may simultaneously establish a connection with the at least one DU and establish a connection with the at least one CU, may establish the connection with the at least one DU first and then establish the connection, and the like.

Referring still to FIG. 5, at operation S520, the at least one gateway may be configured to perform an action to the one or more of (a) the at least one DU, and (b) the at least one CU, to which the at least one gateway has established the connection at operation S510. Descriptions of example use cases involving possible actions that may be performed by the at least one gateway are provided below with reference to FIG. 6 to FIG. 8.

### Example Use Case 1: Data Packet Transmission Management

In the related art, the transmission of data packets are managed by the CU. For instance, the CU may receive one or more data packets from the DU(s), may process the one or more data packets, and may further perform one or more actions thereafter (e.g., generate one or more messages based on the received data packet(s), determine the target location(s) of the received data packet(s), etc.) when required. In case the CU does not have sufficient resources to manage or process the data packet(s), the transmission of the data packets may be delayed, which in turns degrade the performance of the network.

As will be described hereinbelow, example embodiments of the present disclosure utilize at least one gateway to manage data packets transmission among network elements, which in turns remedy the above described issue in the related art.

FIG. 6 illustrates a flow diagram of a method 600 for managing data packets transmission among network elements of ORAN, according to one or more embodiments. One or more operations of method 600 may be part of operation S520 in FIG. 5, and may be performed by the at least one gateway to manage data packets transmission among the at least one DU and/or the at least one CU, to which the at least one gateway has established a connection (at operation S510 in FIG. 5).

Referring to FIG. 6, at operation S610, the at least one gateway may be configured to receive one or more data packets. Specifically, the at least one gateway may be configured to receive the one or more data packets from the at least one DU and/or from the at least one CU.

According to embodiments in which the at least one gateway has established a connection with the at least one DU, the at least one gateway may receive one or more data packets from the at least one DU. The one or more data packets may include one or more protocol data units (PDUs), one or more service data units (SDUs), one or more CU information (e.g., base station ID, Service Access Point label, etc.), and/or any other suitable information. The one or more PDUs may include at least one PDU for a Signaling Radio Bearer (SRB), at least one PDU for a Data Radio Bearer (DRB), or a combination thereof. Further, the at least one gateway may receive the one or more PDUs from the at least one DU via a Radio Link Control (RLC) layer.

According to embodiments in which the at least one gateway has established a connection with the at least one CU, the at least one gateway may receive one or more data packets from the at least one CU. The one or more data packets may include one or more PDUs, one or more SDUs, one or more DU information (e.g., DU ID, RLC information associated with the DU, etc.), and/or any other suitable information. The one or more PDUs may include at least one PDU for a SRB, at least one PDU for a DRB, or a combination thereof. Further, the at least one gateway may receive the one or more PDUs from the at least one CU via a Packet Data Convergence Protocol (PDCP) layer.

According to embodiments in which the at least one gateway has established a connection with the at least one DU and the at least one CU, the at least one gateway may receive one or more data packets from the at least one DU and from the at least one CU in a similar manner as described hereinabove. In this regard, the at least one gateway may simultaneously receive the one or more data packets from the at least one DU and from the at least one CU, or may receive the one or more data packets from the at least one DU and from the at least one CU in any suitable sequential order.

Referring still to FIG. 6, at operation S620, the at least one gateway may be configured to determine a target location to which the received one or more data packets should be transmitted.

According to embodiments in which the at least one gateway has established a connection with the at least one DU, the at least one gateway may determine, based on at least a portion of information included in the received one or more data packets, that the one or more data packets should be transmitted to one or more target CUs. For instance, the one or more data packets may include information of the target CU(s), such as base station ID associated with the target CU(s), Service Access Point (SAP) ID or label associated with the target CU(s), and the like, which the at least one gateway may utilize to determine the target CU(s).

According to embodiments in which the at least one gateway has established a connection with the at least one CU, the at least one gateway may determine, based on at least a portion of information included in the received one or more data packets, that the one or more data packets should be transmitted to one or more target DUs. For instance, the one or more data packets may include information of the target DU(s), such as ID associated with the target DU(s), RLC information associated with the target DU(s), and the like, which the at least one gateway may utilize to determine the target DU(s).

According to embodiments in which the at least one gateway has established a connection with the at least one DU and the at least one CU, the at least one gateway may determine the that the one or more data packets received from the at least one DU should be transmitted to one or more CUs and may determine that the one or more data packets received from the at least one CU should be transmitted to one or more DUs, in a similar manner as described hereinabove. In this regard, the at least one gateway may simultaneously determine the target CU(s) and the target DU(s), or may determine the target CU(s) and the target DU(s) in any suitable sequential order.

Referring still to FIG. 6, at operation S630, the at least one gateway may be configured to transmit the one or more data packets to the target location.

According to embodiments in which the at least one gateway has established a connection with the at least one DU, the at least one gateway may transmit the one or more data packets to the determined target CU(s). For instance, the at least one gateway may transmit the one or more data packets to one or more service access points (SAPs) associated with the determined target CU(s).

According to embodiments in which the at least one gateway has established a connection with the at least one CU, the at least one gateway may, the at least one gateway may transmit the one or more data packets to the determined target DU(s). For instance, the at least one gateway may transmit the one or more data packets to the target DU(s) via the respective RLC layer(s).

According to embodiments in which the at least one gateway has established a connection with the at least one DU and the at least one CU, the at least one gateway may transmit the one or more data packets received from the at least one DU to the target CU(s) and transmit the one or more data packets received from the at least one CU to the target DU(s), in a similar manner as described hereinabove. In this regard, the at least one gateway may simultaneously transmit the one or more data packets to the target CU(s) and to the target DU(s), or may transmit the one or more data packets to the target CU(s) and to the target DU(s) in any suitable sequential order.

It is contemplated that the descriptions provided hereinabove are merely examples of possible embodiments, and the scope of the present disclosure should not be limited thereto. Specifically, method 600 may include one or more operations in addition to operations S610 to S630, without departing from the scope of the present disclosure.

As an example, prior to transmitting the one or more data packets to the target location, the at least one gateway may determine whether or not it is feasible or possible to transmit the one or more data packets to the target location. In some implementation, the at least one gateway may determine whether or not the target DU(s)/target CU(s) is online or is reachable, whether or not the target DU(s)/target CU(s) has sufficient resources to receive or process the one or more data packets, and the like. For instance, before transmitting one or more data packets to the target CU(s), the at least one gateway may perform a connection test (e.g., a ping test, etc.) with the target CU(s) so as to ensure that the target CU(s) is online or is reachable. Further, the at least one gateway may establish a connection with the target CU(s) and retrieve status data (e.g., resource status, health status, etc.) of the target CU(s), before transmitting the one or more data packets to the target CU(s).

According to embodiments, based on determining that it is feasible or possible to transmit the one or more data packets to the target location(s), the at least one gateway may transmit the one or more data packets to the target location(s) accordingly. On the other hand, based on determining that it is not feasible or not possible to transmit the one or more data packets to the target location(s), the at least one gateway may generate a notification message and transmit the notification message to the at least one DU and/or the at least one CU (from which the one or more data packets are received). In some embodiments, the notification message may include a recommendation or information of an alternative location(s) to which the one or more data packets may be transmitted.

As another example, prior to transmitting the one or more data packets to the target location(s), the at least one gateway may process the one or more data packets. By way of an example, the at least one DU may provide the one or more data packets for reporting a fault or an error (e.g., fault or error occurs at the at least one DU, at one or more network cells (e.g., Femtocells, etc.) associated with the at least one DU, at one or more user equipment (UE) or user devices associated with the at least one DU, or the like). In that case, the at least one gateway may generate, based on the one or more data packets, a description message defining or describing the fault/error, and then transmit the generated description message to the target CU(s).

In view of the above, the utilization of the at least one gateway in example embodiments of the present disclosure may reduce or eliminate the loads of the CUs in managing data packets transmission among network elements. Further, since the at least one gateway may perform one or more operations on the received data packet(s) on-behalf of the CU before transmitting the data packet(s) to the CU, the CU may simply utilize the data packet(s) provided by the at least one gateway without further processing the data packet(s). Accordingly, the efficiency and effectiveness of data packets transmission among the network elements may be improved.

### Example Use Case 2: Handover Operation

In the related art, the handover operations are managed by the CU. For instance, the CU may receive one or more data packets from the DU(s), may process the data packet(s) to determine whether or not a handover is required, may determine a target CU to which the DU(s) should be handed over, and may perform the handover operation thereafter. In case the CU does not have sufficient resource to manage or perform the handover operations, the handover may be delayed or may not be performed, which in turns degrade the performance of the network. Further, since the CU is hosted or deployed in RDC, and since the handover operations are complex, the handover operations may take a longer time to be completed as compared to the required/desired timeline.

As will be described hereinbelow, example embodiments of the present disclosure utilize at least one gateway to perform a handover operation, which in turns remedy the above described issues in the related art

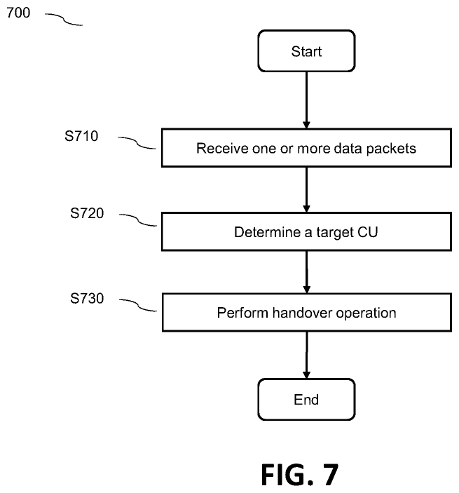

FIG. 7 illustrates a flow diagram of a method 700 for performing a handover operation among network elements of ORAN, according to one or more embodiments. One or more operations of method 700 may be part of operation S520 in FIG. 5, and may be performed by the at least one gateway to perform a handover operation to switch a network element (e.g., a DU, a UE, a network cell, etc.) from a current CU to a new/target CU.

Referring to FIG. 7, at operation S710, the at least one gateway may be configured to receive one or more data packets. For instance, the at least one gateway may receive the one or more data packets from the at least one DU and/or from the at least one CU, in a similar manner described above with reference to operation S610 in FIG. 6. Thus, redundant descriptions associated therewith may be omitted in below for conciseness.

In this regard, the one or more data packets may include information indicating that a handover is required. According to embodiments, the handover may be initiated or requested by the at least one DU and/or the at least one CU to which the at least one gateway is connected (at operation S510 in FIG. 5).

For instance, the at least one DU may determine that a connection with a current CU is becoming weaker and/or may detect another CU which may provide a better service quality (e.g., stronger signal strength, lower latency, etc.). Thus, the at least one DU may transmit the one or more data packets, including the information (e.g., base station ID, SAP information, etc.) of said another CU, to the at least one gateway to request for a handover. Alternatively or additionally, the at least one CU may determine that the status of the at least one CU (e.g., insufficient capacity/computing power for serving the associated DU(s), potential hardware failure, etc.) may not be able to provide sufficient and/or stable service quality to the associated DU(s) (and/or one or more network cells, one or more UE/user devices, etc., associated therewith), and may thus transmit the one or more data packets to the at least one gateway to request for a handover.

According to other embodiments, the handover may be initiated by the at least one gateway. For instance, the at least one gateway may determine, from the one or more data packets received from the at least one DU and/or from the at least one CU, that a handover is required. By way of example, the at least one gateway may determine that a UE connected to the at least one DU has moved from a first location to a second location, and may determine (based on CU information obtained from the one or more storage mediums, etc.) that the current CU to which the at least one DU is coupled is no longer optimal for the UE at the second location (e.g., there is another CU hosted or deployed in a data center nearby the second location and said another CU may provide lower latency than the current CU, etc.). In this regard, the at least one gateway may initiate the handover operation.

Referring still to FIG. 7, at operation S720, the at least one gateway may determine a target CU to which the DU(s) (and/or one or more network cells, one or more UE/user devices, etc., associated therewith) should be switched or handed over. For instance, the one or more data packets received by the at least one gateway may include information associated with the target CU (e.g., base station ID associated with the target CU, information of SAP associated with the target CU, etc.), and the at least one gateway may determine the target CU based on said information.

Additionally or alternatively, the at least one gateway may retrieve information of a plurality of CUs from the one or more storage mediums (e.g., virtualized storages 324-3 in FIG. 3, memory 430 and/or storage component 440 in FIG. 4, etc.), and may determine the target CU from the plurality of CUs based on the information included in the one or more data packets. For instance, the one or more data packets may include status information of the DU (and/or one or more network cells, one or more UE/user devices, etc., associated with the DU), such as the location information, load information, resource requirement, guaranteed service quality, and the like, and may determine which of the plurality of CUs may be the most suitable CU (e.g., CU which may fulfill most of the resource requirement, CU which may provide a service quality (such as latency) closet to the guaranteed service quality, etc.) and then determine said CU as the target CU.

Accordingly, at operation S730, the at least one gateway may be configured to perform a handover operation to switch the connection of the DU(s) from the current CU to the target CU. In this regard, since the at least one gateway may manage the data transmission among the DU(s) and the CU(s) (as described above with reference to FIG. 6), the at least one gateway may simply transmit the one or more data packets from the at least one DU to the target CU (instead of transmitting the one or more data packets to the current CU), which in turns accomplish the handover operation.

In view of the above, the utilization of the at least one gateway in example embodiments of the present disclosure may reduce or eliminate the loads of the CUs in performing handover operation, may simplify the handover operation, and may increase the efficiency of handover operation.

### Example Use Case 3: Restarting Network Element

In the related art, the operations for restarting one or more network elements (e.g., DU, etc.) are managed and performed by the CU. For instance, the CU may receive one or more data packets from the DU(s), may process the data packet(s) to determine whether or not a restart operation is required for a network element(s), may generate a control message for restarting the network element(s), and the like. In case the CU does not have sufficient resource to manage or perform the restart operation, the restart of the associated network elements) may be delayed or may not be performed, which in turns degrade the performance of the network. Further, since the CU is hosted or deployed in RDC, the restart operation for network element(s) at the user end (e.g., UE, network cells, etc.) may take a longer time to be completed as compared to the desired or required timeline.

As will be described hereinbelow, example embodiments of the present disclosure utilize at least one gateway to perform a restart operation, which in turns remedy the above described issues in the related art

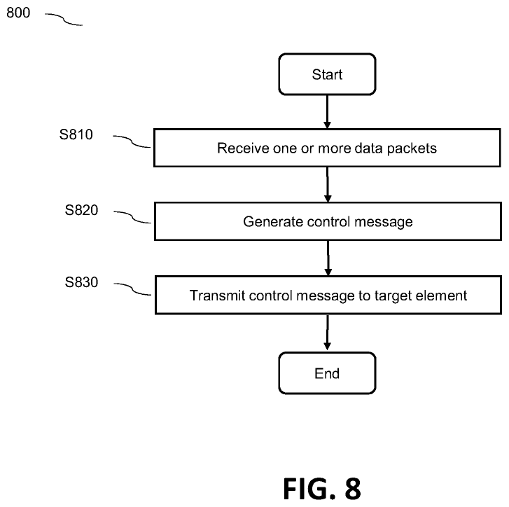

FIG. 8 illustrates a flow diagram of a method 800 for performing a restart operation on a network element of ORAN, according to one or more embodiments. One or more operations of method 800 may be part of operation S520 in FIG. 5, and may be performed by the at least one gateway.

Referring to FIG. 8, at operation S810, the at least one gateway may be configured to receive one or more data packets. For instance, the at least one gateway may receive the one or more data packets from the at least one DU and/or from the at least one CU, in a similar manner described above with reference to operation S610 in FIG. 6. Thus, redundant descriptions associated therewith may be omitted in below for conciseness.

In this regard, the one or more data packets may include information indicating that one or more network elements are required to be restarted. For instance, the at least one DU (to which the at least one gateway is connected) may determine that a firmware update has been installed and the at least one DU should be restarted in order to effectively apply the installed firmware update. In this regard, the at least one DU may transmit the one or more data packets, including information of the installed firmware update (e.g., criticality of the firmware update, required restart time for applying the firmware update, etc.), to the at least one gateway to request for a restart. As another example, the at least one CU (to which the at least one gateway is connected) may determine that a performance of a DU(s) is below a threshold (e.g., below a key performance indicator (KPI), etc.). Thus, the at least one CU may transmit the one or more data packets to the at least one gateway to request a restart of the DU(s) to remedy any inhibiting factor that degrade the performance of the DU(s).

Referring still to FIG. 8, at operation S820, the at least one gateway may be configured to generate a control message to restart the network element. For instance, the control message may include a restart trigger which initiate the restart operation, a restart schedule defining the target time/duration at which restart operation should be initiated, a restart notification including description of the reason(s) why the network element should be restarted, and any other suitable information.

At operation S830, the at least one gateway may be configured to transmit the control message to the network element to-be restarted. Subsequently, the network element may be restarted according to the control message.

It can be understood that, in addition to DU, any other suitable network elements, such as a network cell (e.g., Femtocell, etc.) associated with the DU, a user equipment/user device, a CU, and the like, may also be restarted in a similar manner, when required.

In view of the above, the utilization of the at least one gateway in example embodiments of the present disclosure may reduce or eliminate the loads of the CUs in performing restart operation on the network element(s), may simplify the restart operation, and may increase the efficiency of restart operation.

### Various Aspects of Embodiments

It is contemplated that the example embodiments described hereinabove with reference to FIG. 6 to FIG. 8 are merely examples of possible actions that may be performed by the at least one gateway on-behalf of the CU(s). It can be understood that the at least one gateway may perform one or more additional operations, such as initiating network cell establishment, providing call tracing, performing handover operation from one tower to another tower, providing cell redundancy, and the like, without departing from the scope of the present disclosure.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

In view of the above, various further respective aspects and features of embodiments of the present disclosure may be defined by the following items:
Item [1]: A system including: a plurality of distributed units (DUs); a plurality of central units (CUs); and a server including: a gateway, a memory storing instructions, and at least one processor configured to execute the instructions to configure the gateway to: establish a connection with one or more of: (a) at least one DU of the plurality of DUs, and (b) at least one CU of the plurality of CUs; and perform an action to the one or more of (a) the at least one DU, and (b) the at least one CU.
Item [2]: The system according to item [1], wherein the at least one processor may be configured to execute the instructions to configure the gateway to establish the connection with the at least one DU; and wherein the at least one processor may be configured to execute the instructions to configure the gateway to perform the action by: receiving at least one protocol data unit (PDU) from the at least one DU; determining, from the plurality of CUS, at least one target CU to which the at least one PDU should be transmitted; and transmitting the at least one PDU to the at least one target CU.
Item [3]: The system according to item [1], wherein the at least one processor may be configured to execute the instructions to configure the gateway to establish the connection with the at least one CU; wherein the at least one processor may be configured to execute the instructions to configure the gateway to perform the action by: receiving at least one protocol data unit (PDU) from the at least one CU; determining, from the plurality of DUs, at least one target DU to which the at least one PDU should be transmitted; and transmitting the at least one PDU to the at least one target DU.
Item [4]: The system according to item [2], wherein the receiving the at least one PDU may include receiving the at least one PDU from the at least one DU via a Radio Link Control (RLC) layer; and wherein the at least one PDU may include at least one PDU for a signaling radio bearer (SRB), at least one PDU for a data radio bearer (DRB), or a combination thereof.
Item [5]: The system according to item [3], wherein the receiving the at least one PDU may include receiving the at least one PDU from the at least one CU via a Packet Data Convergence Protocol (PDCP) layer; and wherein the at least one PDU may include at least one PDU for a SRB, at least one PDU for a DRB, or a combination thereof.
Item [6]: The system according to any one of items [1]-[5], wherein the server may be a server of an edge data center.
Item [7]: The system according to item [6], wherein the server may be a server cluster, wherein the server cluster may include at least one master node and a plurality of worker nodes associated with the at least one master node, and wherein the gateway may be hosted in the at least one master node, the plurality of worker nodes, or a combination thereof.
Item [8]: A method, performed by a gateway of a server, including: establishing, by the gateway, a connection with one or more of: (a) at least one distributed unit (DU) of a plurality of DUs, and (b) at least one central unit (CU) of a plurality of CUs; and performing, by the gateway, an action to the one or more of (a) the at least one DU, and (b) the at least one CU.
Item [9]: The method according to item [8], wherein the establishing the connection may include establishing the connection with the at least one DU; wherein the performing the action may include: receiving at least one protocol data unit (PDU) from the at least one DU; determining, from the plurality of CUs, at least one target CU to which the at least one PDU should be transmitted; and transmitting the at least one PDU to the at least one target CU.
Item [10]: The method according to item [8], wherein the establishing the connection may include establishing the connection with the at least one CU; wherein the performing the action may include: receiving at least one protocol data unit (PDU) from the at least one CU; determining, from the plurality of DUs, at least one target DU to which the at least one PDU should be transmitted; and transmitting the at least one PDU to the at least one target DU.
Item [11]: The method according to item [9], wherein the receiving the at least one PDU may include receiving the at least one PDU from the at least one DU via a Radio Link Control (RLC) layer; and wherein the at least one PDU may include at least one PDU for a signaling radio bearer (SRB), at least one PDU for a data radio bearer (DRB), or a combination thereof.
Item [12]: The method according to item [10], wherein the receiving the at least one PDU may include receiving the at least one PDU from the at least one CU via a Packet Data Convergence Protocol (PDCP) layer; and wherein the at least one PDU may include at least one PDU for a SRB, at least one PDU for a DRB, or a combination thereof.
Item [13]: The method according to any one of items [8]-[12], wherein the server may be a server of an edge data center.
Item [14]: The method according to item [13], wherein the server may be a server cluster, wherein the server cluster may include at least one master node and a plurality of worker nodes associated with the at least one master node, and wherein the gateway may be hosted in the at least one master node, the plurality of worker nodes, or a combination thereof.
Item [15]: A non-transitory computer-readable recording medium having recorded thereon instructions executable by at least one processor to cause the at least one processor to configure a gateway of a server to perform a method including: establishing, by the gateway, a connection with one or more of: (a) at least one distributed unit (DU) of a plurality of DUs, and (b) at least one central unit (CU) of a plurality of CUs; and performing, by the gateway, an action to the one or more of (a) the at least one DU, and (b) the at least one CU.
Item [16]: The non-transitory computer-readable recording medium according to item [15], wherein the establishing the connection may include establishing the connection with the at least one DU; wherein the performing the action may include: receiving at least one protocol data unit (PDU) from the at least one DU; determining, from the plurality of CUs, at least one target CU to which the at least one PDU should be transmitted; and transmitting the at least one PDU to the at least one target CU.
Item [17]: The non-transitory computer-readable recording medium according to item [15], wherein the establishing the connection may include establishing the connection with the at least one CU; wherein the performing the action may include: receiving at least one protocol data unit (PDU) from the at least one CU; determining, from the plurality of DUs, at least one target DU to which the at least one PDU should be transmitted; and transmitting the at least one PDU to the at least one target DU.
Item [18]: The non-transitory computer-readable recording medium according to item [16], wherein the receiving the at least one PDU may include receiving the at least one PDU from the at least one DU via a Radio Link Control (RLC) layer; and wherein the at least one PDU may include at least one PDU for a signaling radio bearer (SRB), at least one PDU for a data radio bearer (DRB), or a combination thereof.
Item [19]: The non-transitory computer-readable recording according to item [17], wherein the receiving the at least one PDU may include receiving the at least one PDU from the at least one CU via a Packet Data Convergence Protocol (PDCP) layer; and wherein the at least one PDU may include at least one PDU for a SRB, at least one PDU for a DRB, or a combination thereof.
Item [20]: The non-transitory computer-readable recording according to any one of items [15]-[19], wherein the server may be a server of an edge data center.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a plurality of distributed units (DUs);
a plurality of central units (CUs);
a server comprising: a gateway, a memory storing instructions, and at least one processor configured to execute the instructions to configure the gateway to:
establish a connection with one or more of: (a) at least one DU of the plurality of DUs, and (b) at least one CU of the plurality of CUs; and
perform an action to the one or more of (a) the at least one DU, and (b) the at least one CU.

2. The system according to claim 1,
wherein the at least one processor is configured to execute the instructions to configure the gateway to establish the connection with the at least one DU;
wherein the at least one processor is configured to execute the instructions to configure the gateway to perform the action by:
receiving at least one protocol data unit (PDU) from the at least one DU;
determining, from the plurality of CUs, at least one target CU to which the at least one PDU should be transmitted; and
transmitting the at least one PDU to the at least one target CU.

3. The system according to claim 1,
wherein the at least one processor is configured to execute the instructions to configure the gateway to establish the connection with the at least one CU;
wherein the at least one processor is configured to execute the instructions to configure the gateway to perform the action by:
receiving at least one protocol data unit (PDU) from the at least one CU
determining, from the plurality of DUs, at least one target DU to which the at least one PDU should be transmitted; and
transmitting the at least one PDU to the at least one target DU.

4. The system as claimed in claim 2, wherein the receiving the at least one PDU comprises receiving the at least one PDU from the at least one DU via a Radio Link Control (RLC) layer; and wherein the at least one PDU comprises at least one PDU for a signaling radio bearer (SRB), at least one PDU for a data radio bearer (DRB), or a combination thereof.

5. The system as claimed in claim 3, wherein the receiving the at least one PDU comprises receiving the at least one PDU from the at least one CU via a Packet Data Convergence Protocol (PDCP) layer; and wherein the at least one PDU comprises at least one PDU for a SRB, at least one PDU for a DRB, or a combination thereof.

6. The system as claimed in claim 1, wherein the server is a server of an edge data center.

7. The system as claimed in claim 6, wherein the server is a server cluster, wherein the server cluster comprises at least one master node and a plurality of worker nodes associated with the at least one master node, and wherein the gateway is hosted in the at least one master node, the plurality of worker nodes, or a combination thereof.

8. A method, performed by a gateway of a server, comprising:
establishing, by the gateway, a connection with one or more of: (a) at least one distributed unit (DU) of a plurality of DUs, and (b) at least one central unit (CU) of a plurality of CUs; and
performing, by the gateway, an action to the one or more of (a) the at least one DU, and (b) the at least one CU.

9. The method as claimed in claim 8,
wherein the establishing the connection comprises establishing the connection with the at least one DU;
wherein the performing the action comprises:
receiving at least one protocol data unit (PDU) from the at least one DU;
determining, from the plurality of CUs, at least one target CU to which the at least one PDU should be transmitted; and
transmitting the at least one PDU to the at least one target CU.

10. The method as claimed in claim 8,
wherein the establishing the connection comprises establishing the connection with the at least one CU;
wherein the performing the action comprises:
receiving at least one protocol data unit (PDU) from the at least one CU;
determining, from the plurality of DUs, at least one target DU to which the at least one PDU should be transmitted; and
transmitting the at least one PDU to the at least one target DU.

11. The method as claimed in claim 9, wherein the receiving the at least one PDU comprises receiving the at least one PDU from the at least one DU via a Radio Link Control (RLC) layer; and wherein the at least one PDU comprises at least one PDU for a signaling radio bearer (SRB), at least one PDU for a data radio bearer (DRB), or a combination thereof.

12. The method as claimed in claim 10, wherein the receiving the at least one PDU comprises receiving the at least one PDU from the at least one CU via a Packet Data Convergence Protocol (PDCP) layer; and wherein the at least one PDU comprises at least one PDU for a SRB, at least one PDU for a DRB, or a combination thereof.

13. The method as claimed in claim 8, wherein the server is a server of an edge data center.

14. The method as claimed in claim 13, wherein the server is a server cluster, wherein the server cluster comprises at least one master node and a plurality of worker nodes associated with the at least one master node, and wherein the gateway is hosted in the at least one master node, the plurality of worker nodes, or a combination thereof.

15. A non-transitory computer-readable recording medium having recorded thereon instructions executable by at least one processor to cause the at least one processor to configure a gateway of a server to perform a method comprising:
establishing, by the gateway, a connection with one or more of: (a) at least one distributed unit (DU) of a plurality of DUs, and (b) at least one central unit (CU) of a plurality of CUs; and
performing, by the gateway, an action to the one or more of (a) the at least one DU, and (b) the at least one CU.

16. The non-transitory computer-readable recording medium as claimed in claim 15,
wherein the establishing the connection comprises establishing the connection with the at least one DU;
wherein the performing the action comprises:
receiving at least one protocol data unit (PDU) from the at least one DU;
determining, from the plurality of CUs, at least one target CU to which the at least one PDU should be transmitted; and
transmitting the at least one PDU to the at least one target CU.

17. The non-transitory computer-readable recording medium as claimed in claim 15,
wherein the establishing the connection comprises establishing the connection with the at least one CU;
wherein the performing the action comprises:
receiving at least one protocol data unit (PDU) from the at least one CU;
determining, from the plurality of DUs, at least one target DU to which the at least one PDU should be transmitted; and
transmitting the at least one PDU to the at least one target DU.

18. The non-transitory computer-readable recording medium as claimed in claim 16, wherein the receiving the at least one PDU comprises receiving the at least one PDU from the at least one DU via a Radio Link Control (RLC) layer; and wherein the at least one PDU comprises at least one PDU for a signaling radio bearer (SRB), at least one PDU for a data radio bearer (DRB), or a combination thereof.

19. The non-transitory computer-readable recording medium as claimed in claim 17, wherein the receiving the at least one PDU comprises receiving the at least one PDU from the at least one CU via a Packet Data Convergence Protocol (PDCP) layer; and wherein the at least one PDU comprises at least one PDU for a SRB, at least one PDU for a DRB, or a combination thereof.

20. The non-transitory computer-readable recording medium as claimed in claim 15, wherein the server is a server of an edge data center.
